(19) United States
(12) Patent Application Publication
(10) Pub. No.: US 2009/0015432 A1
(43) Pub. Date: Jan. 15, 2009

(54) Remote Control System for Electronic Devices

(76) Inventors: Nathan Barsetti, San Francisco, CA (US); J. Daniel Sebelia, Oakland, CA (US); Justin Porcano, Oakland, CA (US)

Correspondence Address: Rubinstein Law Group;A Professional Law Corporation, 340 Brannan Street, Suite 304, San Francisco, CA, 94107, US

(21) Appl. No.: 11/775,352

(22) Filed: Jul. 10, 2007

(51) Int. Cl. G08C 19/00

(52) U.S. Cl. 340/825.69

(57) ABSTRACT

The invention includes a control system for a electronic devices that generally includes interfaces integrated into a piece of apparel, where the apparel can be worn by an individual. The interface has one or more actuable members and the system has a port and a contact. The contact is communicatively coupled to the interface and to the port, and is operable to receive commands from the interface when any of the actuable members are actuated. A transmitter is supplied and is operable to contact the contact and receive commands from the interface. The transmitter is associated with a receiver, and is operable to send to the receiver the commands received from the interface. The apparel can be sports apparel. The apparel can be made from a man-made fabric or can be made from a natural material. The port can be a recess, and the transmitter is inserted into the recess.

### FIELD

The current application is directed to a means for embedding a wireless communication device within wearable apparel. Specifically, an embodiment of the device enables a user to have control signals relayed from user interaction to a wireless electronic device.

### BACKGROUND

Many people currently use electronic equipment, such as cell phones, mp-3 players, and various other items. Many times the electronic interface to them requires manual manipulation, such as accessing program keys, fast forward, pause, volume, and the like. However, many times the ability to interface with these items is limited.

In some cases, items can be equipped with low power radio frequency (RF) and/or infrared (IR) control and/or data channels. For example, many cell phones are operated “hands-free” with Bluetooth-enabled data paths between an earpiece and a base unit, and commands can be enabled as well.

However, many times the carrying of such added equipment can be troublesome, due to the added “carry-factor” of the controls. For example, when operating a Bluetooth-enabled cell phone, the cell phone must still be accessed to operate the many controls. In the case of an MP3 player, such controls as volume, next selection, previous selection, fast forward, rewind, start, and stop, must be accessed individually on the unit. In this case, there is no easy, accessible means to operate these controls.

In many environments, one may not be able to access a device due to the fact that it may take both hands to accomplish the wanted function, since one typically has to hold the unit and press a button at the same time. In many work and leisure environments, such extra access may be bothersome. If one is engaged with work, one may not be able to access such functions in an easy manner due to the presence of work materials or tools in ones' hand, not to mention the cases when one needs to use all of their hands to accomplish a work function. In leisure activities, such as skiing or hiking, one can face similar restrictions in manipulating the equipment.

### DESCRIPTION OF THE DRAWINGS

FIG. 1 is a diagram of the system implemented in a wristband format.

FIG. 2 depicts how the transmitter and housing for the interface can interact in one implementation.

FIG. 3 is a data schematic for an RF unit and interface used in the system.

FIG. 4 is a logical flow schematic of one embodiment of the device.

FIG. 5 is depicts the system implemented in a number of differing pieces of apparel, including pants, tops, and differing placements integrated within such apparel.

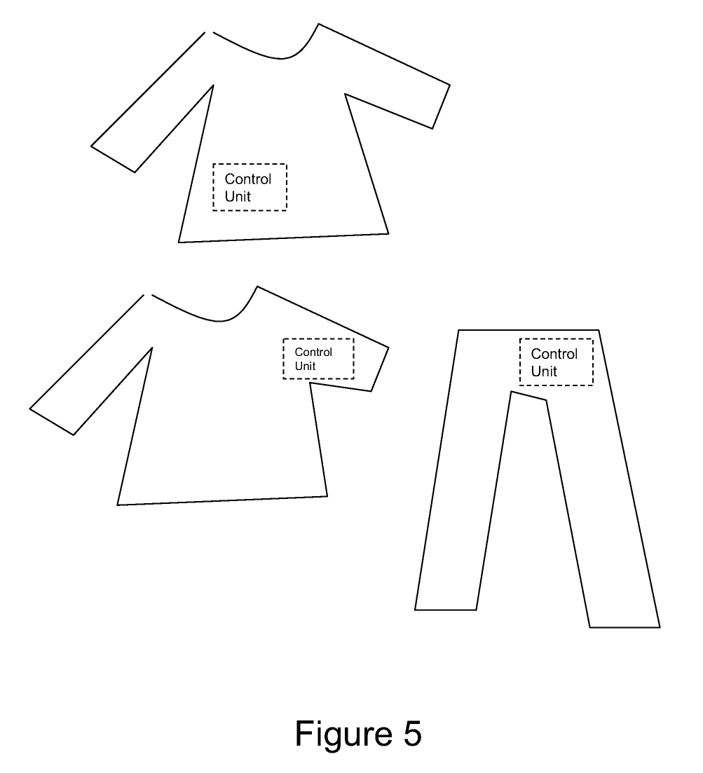

### DETAILED DESCRIPTION

Reference will now be made in detail to implementations of the present invention as illustrated in the accompanying drawings. The drawings may not be to scale. The same reference indicators will be used throughout the drawings and the following detailed description to refer to identical or like elements. In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application, safety regulations and business related constraints, and that these specific goals will vary from one implementation to another and from one developer to another. Moreover, it will be appreciated that such a development effort will be a routine undertaking of engineering for those of ordinary skill in the art having the benefit of this disclosure.

The current application envisions apparel that contains a human interface, a detachable RF transmitter, and a RF receiver for connection to any electronic device. The human interface has a plurality of controls, and a docking recess for the transmitter. The transmitter can have a battery that can be recharged.

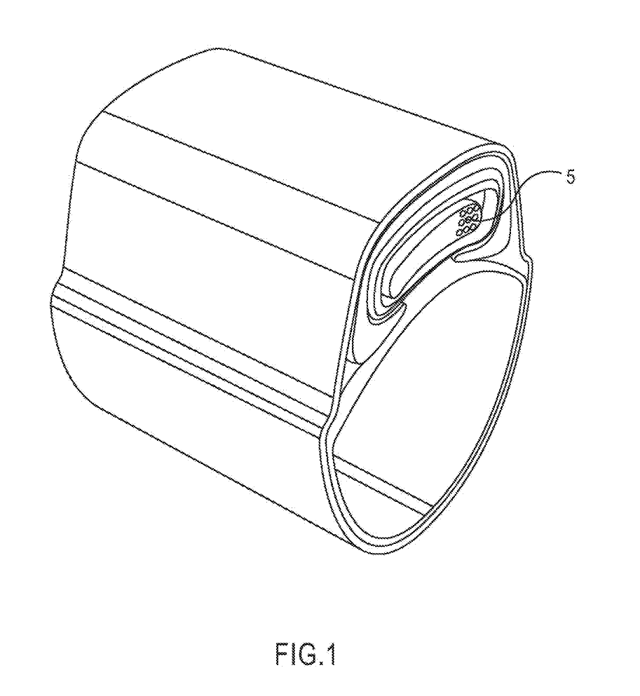

FIG. 1 is a diagram of such a unit in the form of a wristband. In this form, the unit can be worn easily on an arm, or, sewn into a piece of apparel.

When the transmitter 5 is plugged into the recess, this initiates power from the battery. A contact sensor is supplied, such that when the transmitter is not placed into the recess, the transmitter is not powered, and power is not supplied to any external interface, thus saving power.

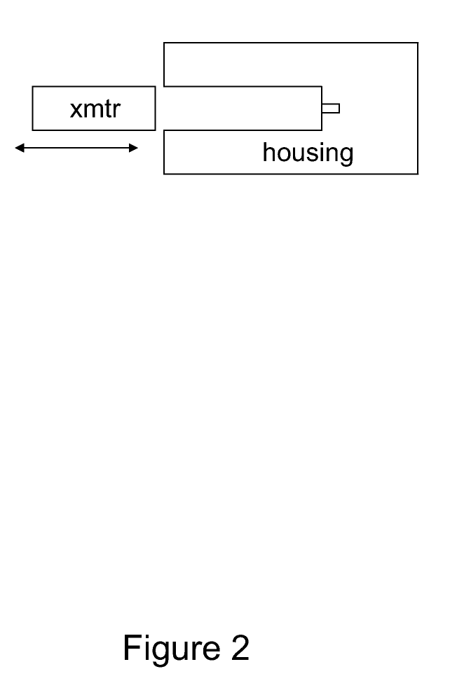

FIG. 2 depicts how the transmitter and housing for the interface can interact in one implementation. In this case, the transmitter can be slid in and out of the housing.

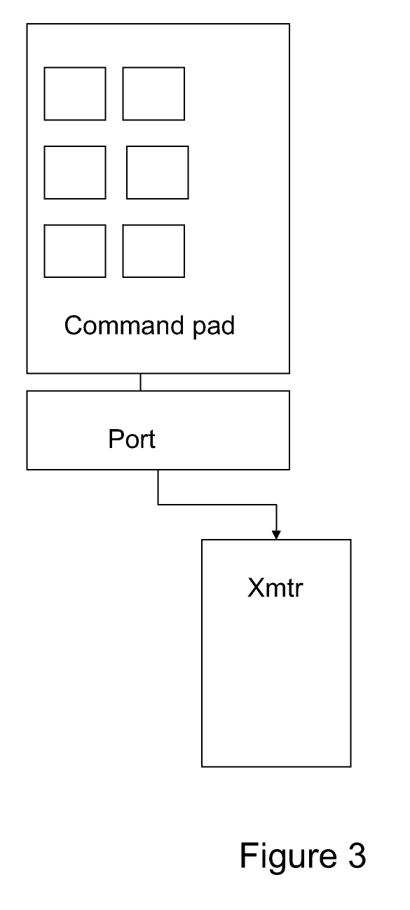

FIG. 3 is a data schematic for such an RF unit and interface. The interface has a plurality of controls, each operable to be actuated by a human. The recess also has connections for control data from the interface. Thus, when any control is actuated, the data is relayed from the interface to the transmitter. The transmitter interprets the controls being placed from the interface, and outputs an appropriate RF (or IR) signal to a receiver.

The receiver unit is plugged into a connection port of the then-being-used device. When the receiver receives the signal output from the transmitter, it passes these on to the device itself. The device then performs the appropriate function.

In one embodiment, the interface may utilize a touch-screen technology as the human interface, in part or in total. In this embodiment, the touch screen can be programmed specifically for any attached devices. Thus, when accessing a phone, a number pad can be displayed. Alternatively, when accessing an audio device, a number screen for track number, and fast forward, rewind, next selection, and previous selection may be accessed. In the case of a video device, such as an MP3 viewer, a zoom command may be implemented through the touch screen.

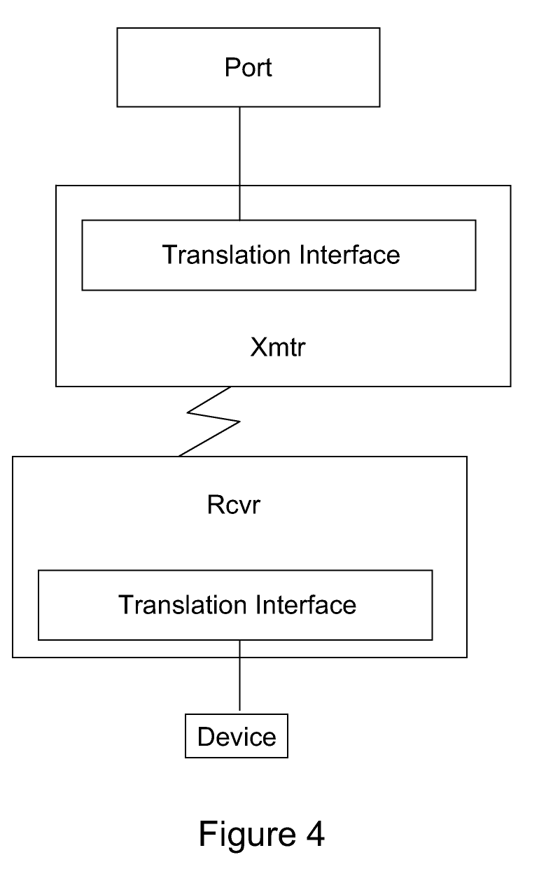

FIG. 4 is a logical flow schematic of one embodiment of the device. The commands from the interface are sent to the transmitter unit. A logical programming layer may be disposed between the interface and the transmitter unit, which directs the transmitter to send a particular command sequence. In this manner, multiple types of commands for multiple types of devices may be accounted for within the transmitter itself without having to alter the receiver or the transmitter physically. A data port may be supplied with the transmitter in order to allow a user to change out the command sequence. In this manner, the receiver and transmitter may be used with any numbers of diverse pieces of electronic equipment. A translation interface may also be optionally supplied with the receiver, which can also be used more generically with many types of electronic devices.

It should be noted that while some of the Figures depict an armband implementation of the system, the system can be employed as utilized with nearly any type of apparel; including jackets, coats, pants, shirts, sweaters, and anything that one can wear. In these cases, the unit can be directly coupled to and/or integrated into any type of apparel.

Further, the transmitter need not be coupled to the interface via a recessed port. Other methods such as latching or click-attaching can be used to secure the transmitter to the apparel.

A control system for an electronic device is envisioned. The system comprises an interface integrated into a piece of apparel, where the apparel can be worn by an individual. The interface has one or more actuable members. The system has a port and a contact. The contact is communicatively coupled to the interface and to the port, and is operable to receive commands from the interface when any of the actuable members are actuated. A transmitter is supplied and is operable to contact the contact and receive commands from the interface. The transmitter is associated with a receiver, and is operable to send to the receiver the commands received from the interface.

The apparel can be sports apparel. The apparel can be made from a man-made fabric or can be made from a natural material. The port can be a recess, and the transmitter is inserted into the recess. The transmitter can have a power source. In one embodiment, the power source actuates the transmitter when the transmitter is in contact with the contact. The transmitter can have a translation layer, and the commands from the interface are translated for a particular electronic device by the translation layer.

The apparel can fit over the legs of an individual, can be worn across the shoulders of an individual (like a shirt or coat), can be a bib or overall, or can be an armband or leg band.

The electronic device can be a phone, an audio player, a video player, or any combination thereof. The device could also be any other electronic device using human interaction.

A method of operating an electronic device is also envisioned. The method is made up of supplying a piece of apparel having an integrated interface and a port, the interface having actuable members; wearing the apparel; attaching a transmitter to the port; actuating an actuable member; based on the step of actuating, generating a signal; transmitting the signal to the transmitter via the port; transmitting a command to a remote receiver from the transmitter, the command associated with the action of actuating.

The present application has been described in terms of specific embodiments incorporating details to facilitate the understanding of the remotely controlling an electronic device. Many of the components shown and described in the various figures are able to be interchanged to achieve the results necessary, and this description should be read to encompass such interchange as well. As such, references herein to specific embodiments and details thereof are not intended to limit the scope of the claims appended hereto.

We claim:

1. A control system for an electronic device, comprising:
An interface integrated into a piece of apparel, the apparel operable to be worn by an individual, the interface comprising one or more actuable members;
A port;
A contact, communicatively coupled to the interface and to the port, operable to receive commands from the interface when any of the actuable members are actuated
A transmitter, operable to contact the contact and receive commands from the interface;
The transmitter associated to a receiver, the transmitter operable to send to the receiver the commands received from the interface.

2. The system of claim 1 wherein the apparel is sports apparel.

3. The system of claim 1 wherein the apparel is made from a man-made fabric.

4. The system of claim 1 wherein the apparel is made from a natural material.

5. The system of claim 1 wherein the port has a recess and the transmitter is inserted into the recess.

6. The system of claim 1 wherein the transmitter comprises a power source.

7. The system of claim 6 wherein the power source actuates the transmitter when the transmitter is in contact with the contact.

8. The system of claim 1 wherein the transmitter comprises a translation layer, and wherein the commands from the interface are translated for a particular electronic device by the translation layer.

9. The system of claim 1 wherein the apparel fits over the legs of an individual.

10. The system of claim 1 wherein the apparel is worn across the shoulders of an individual.

11. The system of claim 1 wherein the apparel is worn as an armband.

12. The system of claim 1 wherein the electronic device is a cell phone.

13. The system of claim 1 wherein the electronic device is an audio device.

14. A method of operating an electronic device comprising:
Supplying a piece of apparel having an integrated interface and a port, the interface having actuable members;
Wearing the apparel;
Attaching a transmitter to the port;
Actuating an actuable member;
Based on the step of actuating, generating a signal;
Transmitting the signal to the transmitter via the port;
Transmitting a command to a remote receiver from the transmitter, the command associated with the action of actuating.
